(19) United States
(12) Patent Application Publication
(10) Pub. No.: US 2024/0302248 A1
(43) Pub. Date: Sep. 12, 2024

(54) COMPREHENSIVE TIRE HEALTH MODELING AND SYSTEMS FOR THE DEVELOPMENT AND IMPLEMENTATION THEREOF

(71) Applicant: Bridgestone Americas Tire Operations, LLC, Nashville, TN (US)

(72) Inventors: Thomas A. Sams, Akron, OH (US); Anoop G. Varghese, Akron, OH (US)

(73) Assignee: Bridgestone Americas Tire Operations, LLC, Nashville, TN (US)

(21) Appl. No.: 18/656,940

(22) Filed: May 7, 2024

Related U.S. Application Data
(63) Continuation of application No. PCT/US2022/082219, filed on Dec. 22, 2022.
(60) Provisional application No. 63/296,945, filed on Jan. 6, 2022.

(51) Int. Cl. G01M 17/02

(52) U.S. Cl. CPC G01M 17/02

(57) ABSTRACT

A tire health estimation system and method includes aggregating model generation data over time, and iteratively generating tire health models based thereon. The model generation data correlates various combinations of a first set of input values for a given type of tire to each of various tire health variables for each of various tire components. A second set of the input values is measured and/or determined for an actual tire, wherein an appropriate model is selected for at least one tire health variable and at least one tire component based on the second set. Respective tire health variables are estimated for the tire components via the selected model(s) and based on the second set of input values, and an output signal is generated corresponding to a health of the tire based on a comparison of the estimated tire health variables.

### FIELD OF THE INVENTION

The present invention relates generally to the estimation and prediction of tire health for wheeled vehicles. More particularly, an embodiment of an invention as disclosed herein relates to systems and methods for developing, selecting, and implementing models for the characterization and prediction of tire health for tires of wheeled vehicles including but not limited to motorcycles, consumer vehicles (e.g., passenger and light truck), commercial and off-road (OTR) vehicles.

### BACKGROUND

The health of a tire is a valuable insight for end users, whether they be fleet administrators or personal vehicle owners. The health may be characterized as a measure of the remaining useful life (RUL) of the tire and for the purpose of the present disclosure can be broken into at least the categories of tread and carcass.

The tread health may be analogous to tread wear, including for example both even and irregular wear and quantified as a number of miles remaining until the tread is either at a threshold limit (such as a tread wear indicator) or irregular wear has progressed to a point that noise or vibrations produced require the tire to be replaced or retreaded.

Carcass health accounts for normal aging, damage due to impacts such as potholes and curbs, fatigue, and misuse/abuse such as running underinflated/overloaded, too high of speeds, improper application, etc. Carcass removal modes include (but are not limited to) belt edge separations (BES) or belt leaving belt (BLB), belt leaving carcass (BLC), and ply-end separation (PES). Carcass health is also the primary determining factor as to the capability of the tire for retreading.

### BRIEF SUMMARY

By using physics-based and/or data science models, the health or remaining life of each tire component can be estimated based on the history of conditions to which the tire has been exposed. This history may for example be determined either directly or indirectly via tire sensors such as tire pressure monitoring system sensors and/or tire monitor system sensors (TPMS/TMS), and vehicle sensors such as accelerometers, wheel speed sensors, global positioning system (GPS) sensors, etc. Respective models may be required to predict the different removal modes for various components of the tire, wherein a comprehensive tire health model may combine the results of these models into a single health metric.

The current disclosure provides an enhancement to conventional systems, at least in part by introducing a novel digital tire health model. The tire tread/wear may be covered by a digital twin for wear model. The fatigue of various components may be estimated for example via structured learning of fracture mechanics. An underlying assumption may for example be the existence micro-cracks or flaws that begin to grow slowly as the components undergo deformation, wherein the crack growth rate is a function of the current crack length, the strain, and the temperature of the location of interest.

By knowing the load, speed, pressure, and contained air temperature of the tire, a method may be provided to estimate the strain and temperature of different locations of interest in the tire, for example by creating a mapping of these different input conditions to the different locations by utilizing finite element analysis (FEA).

In a first exemplary embodiment, a computer-implemented tire health estimation method as disclosed herein comprises aggregating model generation data in data storage over time, and iteratively generating a plurality of tire health models based on the aggregated model generation data, said model generation data correlating various combinations of a first set of input values for a given type of tire to each of one or more tire health variables for each of a plurality of tire components. A second set of the inputs values is measured and/or determined via one or more sensors associated with a first tire of the given type of tire and/or associated with a vehicle upon which the first tire is mounted. An appropriate model is selected for at least one of the one or more tire health variables with respect to each of one or more of the plurality of tire components based on the measured second set of the input values. Respective tire health variables are estimated for each of the at least one tire component via the one or more selected models and based on the measured second set of the input values. An output signal is generated corresponding to a health of the first tire based on a comparison of the estimated tire health variables.

In a second embodiment, one exemplary aspect according to the above-referenced first embodiment may include that at least one of the input values are directly measured via the one or more sensors and at least one of the input values are determined indirectly via the at least one directly measured input value.

In a third embodiment, one exemplary aspect according to any one of the above-referenced first or second embodiments may further include that the plurality of selectable tire health models comprises fatigue estimation models corresponding to relevant fracture variables for one or more of the plurality of tire components.

The fatigue estimation models may for example comprise crack growth rate models for estimating crack growth rates at each of a plurality of locations on the tire and as a function of at least an estimated strain and temperature at each of the plurality of locations.

In a fourth embodiment, one exemplary aspect according to any one of the above-referenced first to third embodiments may include aggregating the estimated respective tire health variables over time and predicting a remaining useful life of the tire based at least in part on the aggregated variables, wherein the output signal corresponds to the predicted remaining useful life of the tire.

In a fifth embodiment, one exemplary aspect according to at least the above-referenced fourth embodiment may include selecting appropriate models for subsequent iterations of the method based on a newly measured set of the input values and further on historical analysis of the aggregated estimated respective tire health variables over time.

In a sixth embodiment, one exemplary aspect according to any one of the above-referenced first to fifth embodiments may include that the plurality of selectable tire health models comprise aging estimation models accounting for tire-series changes in relevant variables for one or more of the plurality of tire components relative to the type of the first tire.

In a seventh embodiment, one exemplary aspect according to any one of the above-referenced first to sixth embodiments may include that the plurality of selectable tire health models comprise damage estimation models accounting for determined external impacts relevant to tire health for one or more of the plurality of tire components.

In an eighth embodiment, one exemplary aspect according to any one of the above-referenced first to seventh embodiments may include that the plurality of selectable tire health models comprise tire wear estimation models accounting for a determined and/or predicted tread depth.

In a ninth embodiment, one exemplary aspect according to any one of the above-referenced first to eighth embodiments may include that the plurality of selectable tire health models comprise one or more carcass health models for predicting a remaining useful life of the tire based at least in part on a predicted time before occurrence of conditions selected from a group consisting of: belt edge separation; belt leaving belt; belt leaving carcass; and ply end separation.

In a tenth embodiment, one exemplary aspect according to any one of the above-referenced first to ninth embodiments may include that the output signal is generated corresponding to a lowest predicted life remaining from among the estimated tire health variables. Alternatively, the output signal may be generated corresponding to a predicted life remaining based on a combination of interrelated tire health variables as identified from the selected models.

In an eleventh embodiment, one exemplary aspect according to any one of the above-referenced first to tenth embodiments may include that the output signal is selectively generated to a display unit associated with a user interface based on a determined passive intervention alert condition. Alternatively, the output signal may be selectively generated to one or more vehicle control units based on a determined active intervention alert condition.

In a twelfth embodiment, a tire health estimation system as disclosed herein comprises data storage having stored thereon model generation data aggregated over time, and a plurality of tire health models iteratively generated based on the aggregated model generation data, said model generation data correlating various combinations of a first set of input values for a given type of tire to each of one or more tire health variables for each of a plurality of tire components. A computer program product resides on a non-transitory computer readable medium and is executable by a processor to direct performance of operations according to at least one of the above-referenced first to eleventh embodiments.

### BRIEF DESCRIPTION OF THE SEVERAL VIEWS OF THE DRAWINGS

Hereinafter, embodiments of the invention are illustrated in more detail with reference to the drawings.

FIG. 1 is a block diagram representing an exemplary embodiment of a system as disclosed herein.

FIG. 2 is a graphical diagram representing exemplary components of a tire carcass.

FIG. 3 is a flowchart representing an exemplary embodiment of a method as disclosed herein.

FIG. 4 is a graphical diagram representing a particular exemplary embodiment of a method as disclosed herein with respect to a fatigue portion of the tire health model framework.

FIG. 5 is a graphical diagram representing an exemplary summary of results from drum tests for removal mode of belt edge separation (BES).

FIGS. 6a and 6b are graphical diagrams representing an exemplary plotting of measured data against corresponding predicted data using finite element analysis (FEA) model output.

FIG. 7 is a flowchart representing an exemplary process for prediction of vertical load on the tire from sensor measurements (e.g., speed, ambient temperature, inflation pressure, and CAT).

FIG. 8 is a graphical diagram representing an exemplary plotting of measured data against corresponding predicted data using finite element analysis (FEA) model output.

FIG. 9 is a graphical diagram representing an exemplary comparison of predicted contained air temperature with respect to measured contained air temperature for a controlled indoor drum test with variance in both speed and vertical load.

### DETAILED DESCRIPTION

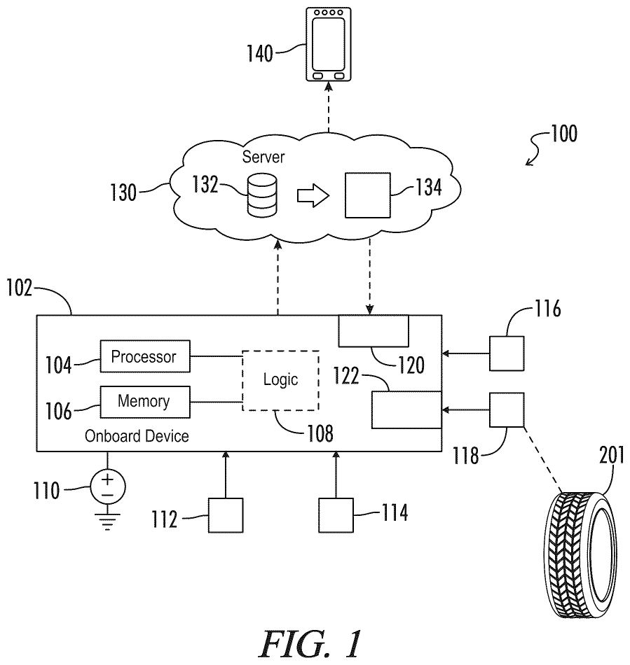

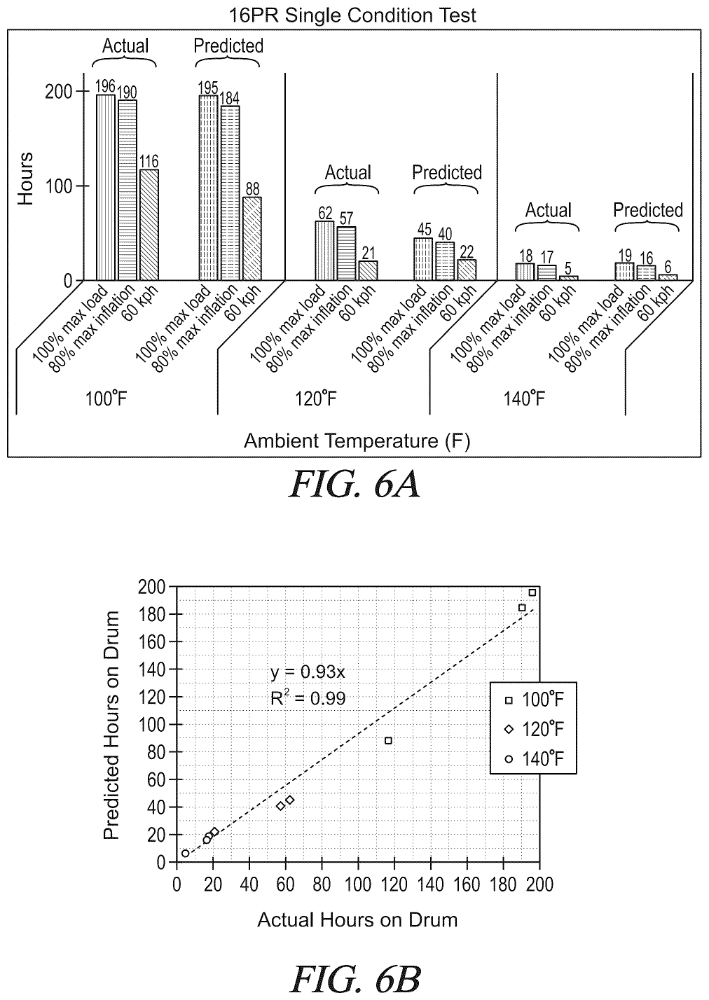

Referring generally to FIGS. 1-9, various exemplary embodiments of an invention may now be described in detail. Where the various figures may describe embodiments sharing various common elements and features with other embodiments, similar elements and features are given the same reference numerals and redundant description thereof may be omitted below.

Various embodiments of a system as disclosed herein may include centralized computing nodes (e.g., a cloud server) in functional communication with a plurality of distributed data collectors and computing nodes (e.g., associated with individual vehicles) for effectively implementing models as disclosed herein. Referring initially to FIG. 1, an exemplary embodiment of the system 100 includes a computing device 102 that is onboard a vehicle and configured to at least obtain data and transmit said data to a remote server 130 and/or perform relevant computations as disclosed herein. The computing device may be portable or otherwise modular as part of a distributed vehicle data collection and control system (as shown), or otherwise may be integrally provided with respect to a central vehicle data collection control system (not shown). The device may include a processor 104 and memory 106 having program logic 108 residing thereon. Generally stated, a system as disclosed herein may implement numerous components distributed across one or more vehicles, for example but not necessarily associated with a fleet management entity, and further a central server or server network in functional communication with each of the vehicles via a communications network. The vehicle components may typically include one or more sensors such as, e.g., vehicle body accelerometers, gyroscopes, inertial measurement units (IMU), position sensors such as global positioning system (GPS) transponders 112, tire pressure monitoring system (TPMS) sensor transmitters 118 and associated onboard receivers, or the like, as linked for example to a controller area network (CAN) bus network and providing signals thereby to local processing units. The illustrated embodiment includes for illustrative purposes, without otherwise limiting the scope of the present invention thereby, an ambient temperature sensor 116, an engine sensor 114 configured for example to provide sensed barometric pressure signals, and a DC power source 110.

In view of the following discussion, other sensors for collecting and transmitting vehicle data such as pertaining to velocity, acceleration, braking characteristics, or the like will become sufficiently apparent to one of ordinary skill in the art and are not further discussed herein. Various bus interfaces, protocols, and associated networks are well known in the art for the communication of vehicle kinetics data or the like between the respective data source and the local computing device, and one of skill in the art would recognize a wide range of such tools and means for implementing the same.

In optional embodiments, data sources as disclosed herein are not necessarily limited to vehicle-specific sensors and/or gateway devices, and can also include third party entities and associated networks, program applications resident on a user computing device 140 such as a driver interface, a fleet management interface, and any enterprise devices or other providers of raw streams of logged data as may be considered relevant for algorithms and models as disclosed herein.

The system may include additional distributed program logic such as for example residing on a fleet management server or other user computing device 140, or a user interface of a device resident to the vehicle or associated with a driver thereof (not shown) for real-time notifications (e.g., via a visual and/or audio indicator), with the fleet management device in some embodiments being functionally linked to the onboard device via a communications network. System programming information may for example be provided on-board by the driver or from a fleet manager.

Vehicle and tire sensors may in an embodiment further be provided with unique identifiers, wherein the onboard device processor 104 can distinguish between signals provided from respective sensors on the same vehicle, and further in certain embodiments wherein a central server 130 and/or fleet maintenance supervisor client device 140 may distinguish between signals provided from tires and associated vehicle and/or tire sensors across a plurality of vehicles. In other words, sensor output values may in various embodiments be associated with a particular tire, a particular vehicle, and/or a particular tire-vehicle system for the purposes of onboard or remote/downstream data storage and implementation for calculations as disclosed herein. The onboard device processor may communicate directly with the hosted server as shown in FIG. 1, or alternatively the driver's mobile device or truck-mounted computing device may be configured to receive and process/transmit onboard device output data to the hosted server and/or fleet management server/device.

Signals received from a particular vehicle and/or tire sensor may be stored in onboard device memory, or an equivalent data storage unit functionally linked to the onboard device processor, for selective retrieval as needed for calculations according to the method disclosed herein. In some embodiments, raw data signals from the various signals may be communicated substantially in real time from the vehicle to the server. Alternatively, particularly in view of the inherent inefficiencies in continuous data transmission of high frequency data, the data may for example be compiled, encoded, and/or summarized for more efficient (e.g., periodic time-based or alternatively defined event-based) transmission from the vehicle to the remote server via an appropriate communications network.

The vehicle data and/or tire data, once transmitted via a communications network to the hosted server 130, may be stored for example in a database 132 associated therewith. The server may include or otherwise be associated with tire health models 134 and optionally related models such as tire traction models for selectively retrieving and processing the vehicle data and/or tire data as appropriate inputs. The models may be implemented at least in part via execution of a processor, enabling selective retrieval of the vehicle data and/or tire data and further in electronic communication for the input of any additional data or algorithms from a database, lookup table, or the like that is stored in association with the server.

As represented for example in FIG. 1, a feedback signal corresponding to a predicted tire wear status (e.g., predicted tread depth at a given distance, time, or the like) may be provided via an interface 120 to an onboard device 102 associated with the vehicle itself, or to a mobile device 140 associated with a user, such as for example integrating with a user interface configured to provide alerts or notice/recommendations that a tire should or soon will need to be replaced.

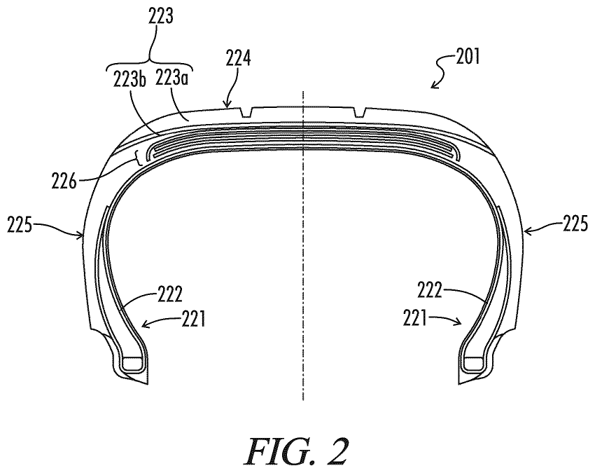

Referring next to FIG. 2, a representative pneumatic tire 201 includes at least: a carcass 222 composed of one or more carcass plies of radially arranged cords toroidally extending between a pair of bead portions 221; and a tread rubber 223 provided on the tire radial outer side of the carcass 222.

In more detail, the exemplary tire 201 includes: a tread portion 224; a pair of sidewall portions 225 continuously extending from the sides of the tread portion 224 inward in the tire radial direction; the bead portions 221 continuous from the tire radial inner ends of the respective sidewall portions 225; and the carcass 222 composed of one or more carcass plies toroidally extending between the pair of bead portions 221 and reinforcing each portion. A bead core is buried in each bead portion 221. A rubber chafer is provided on the outer surface of each bead portion 221, as a reinforcement member of the bead portion 221. A belt 226 composed of one or more belt layers is provided in the crown portion of the carcass 222. The tread rubber 223 is located on the tire radial outer side of the crown portion of the carcass 222.

In the exemplary tire 201, the tread rubber 223 includes a tread surface rubber layer 223a located at the outermost surface of the tread, and a tread inside rubber layer 223b located on the tire radial inner side of the tread surface rubber layer 223a. The 100% modulus of the tread surface rubber layer 223a is higher than the 100% modulus of the tread inside rubber layer 223b. In the tire 201 as represented for example in FIG. 1, the tread rubber 223 may be composed of two or more rubber layers. In other words, a plurality of tread inside rubber layers 223b may be provided.

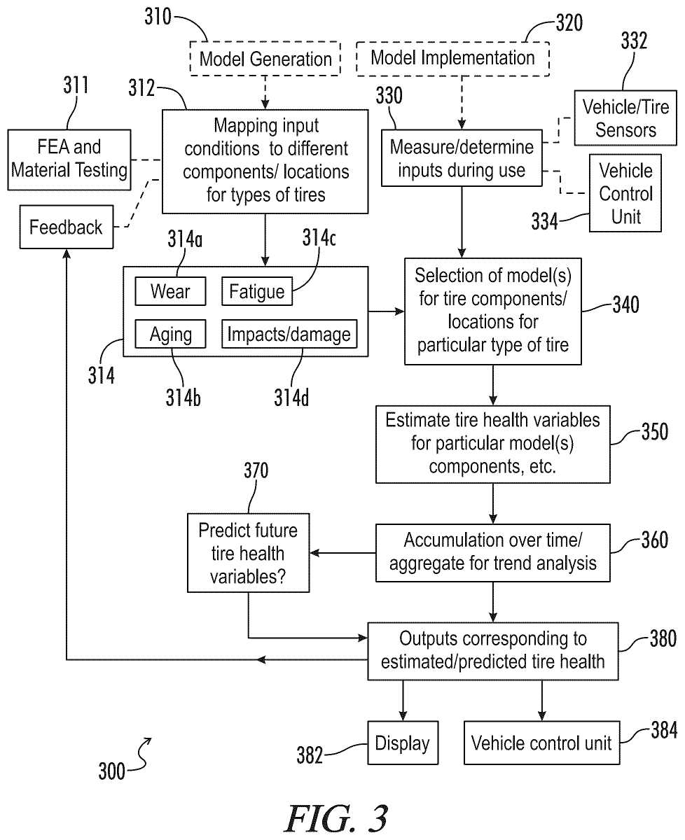

Referring next to FIG. 3, an exemplary embodiment of a method 300 as disclosed herein for determining tire health may be implemented as follows.

A preliminary model generation stage 310 may be performed, including for example mapping of input conditions to different components (which may for example include locations thereof or thereon) for respective types of tires (step 312). Generally stated, model generation data may be aggregated in data storage over time, and a plurality of tire health models iteratively generated based on the aggregated model generation data, with the model generation data correlating various combinations of a set of input values for a given type of tire to each of one or more tire health variables for each of the tire components. In some cases, this process may include drum testing for a given tire specification, such as for example running the tire with an accelerometer attached to the inner liner and collecting data at known parameters including load, speed, pressure, tread depth, and the like. The physical test may generally be replaced or at least supplemented in certain embodiments with finite element simulations and material testing of the tire (step 311). In certain embodiments, model development may further incorporate feedback data to improve upon initial correlations between input data sets and relevant outputs for a given model 314, using for example machine learning techniques. Unless otherwise stated, models as disclosed herein may initially be generated and subsequently implemented and/or modified by a given entity, or an entity may merely selectively retrieve one or more models for implementation that have been generated by another.

Exemplary such models and respective outputs may include (without limitation): tire wear estimation models 314a accounting for a determined and/or predicted tread depth; tire aging estimation models 314b accounting for tire-series changes in relevant variables for certain tire components relative to the type of tire; tire fatigue estimation models 314c corresponding to relevant fracture variables for certain tire components; time damage estimation models 314d accounting for determined external impacts relevant to tire health for certain tire components; and the like. In some embodiments, carcass health models may be developed and selectable for predicting a remaining useful life of the tire based at least in part on a predicted time before occurrence of conditions such as for example belt edge separation, belt leaving belt, belt leaving carcass, ply end separation, and the like.

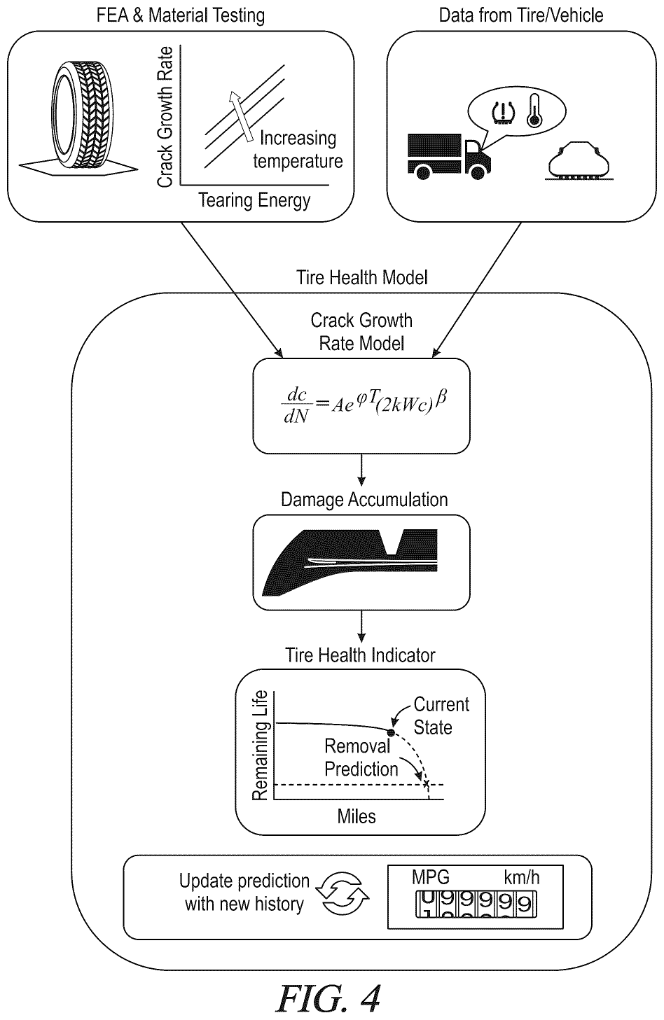

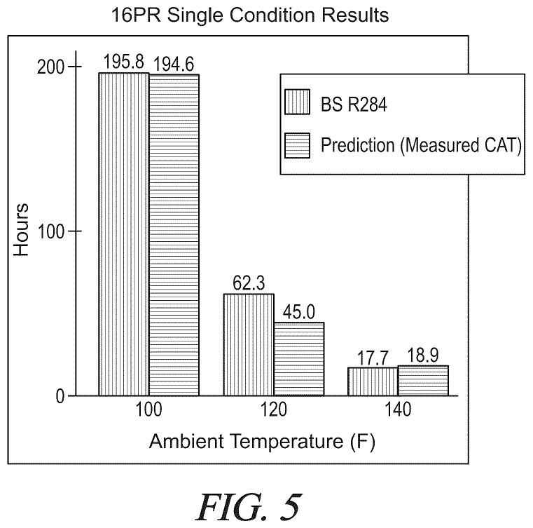

An exemplary tire fatigue estimation model as represented in FIG. 4 may include a crack growth rate model for estimating crack growth rates at each of a plurality of locations on the tire and as a function of at least an estimated strain and temperature at each of various locations of interest. The exemplary fatigue model has been validated using various drum tests, as represented in FIG. 5 for the removal mode of belt edge separation (BES) to summarize actual results for a Bridgestone R284 Ecopia™ tire with respect to predicted results using measured contained air temperature (CAT).

In another example, a physics-based tire model may be developed by two-dimensional modeling of a tire as a flexible ring on an elastic foundation (REF). The tire belt package is modeled as a flexible ring, the tread is modeled as continuous radial springs, and the carcass is modeled as a foundation of radial springs. The model has several variables related to the tire structure (such as the stiffness values associated with these different springs), as well as the condition of the tire (such as load, pressure, speed, tread depth, etc.). The model may for example be loaded against a flat or curved surface (e.g., a road or drum), wherein radial deformation response of the ring may be calculated and further analyzed in accordance with changes to one or more of load, pressure, speed, tread depth, and the like. From the determined deformation, a steady-state acceleration can be easily extracted if needed for further analysis.

Returning to FIG. 3, a model implementation stage 320 may include measuring or otherwise determining relevant input values associated with an actual vehicle-mounted tire during use (step 330), for example via vehicle/tire sensors 332 and/or a vehicle control unit 334 as previously described. Exemplary sensors 332 may include tire sensors such as TPMS/TMS, and/or vehicle sensors such as accelerometers, wheel speed sensors, GPS, and the like. In some cases, all input values may be directly measured via respective sensors, but in various embodiments it may be understood that some input values may be determined indirectly from other directly measured input values. It may also be understood that whereas some input values are collected in a substantially continuous manner, other input values may be collected periodically when available, particularly for example where those inputs may be very slow to change over time and reliably assumed where the most recent measurement was within a certain window in time. Upon collecting an appropriate set of real inputs (e.g., which may include values for inputs corresponding to the set of inputs used for model generation), one or more models 314 may be selectively retrieved for particular tire components with respect to the respective type of tire (or vehicle-tire combination) at issue (step 340).

The method 300 may continue in step 350 by using the selected models to estimate respective tire health variables for each relevant tire component, via the measured or otherwise determined set of input values. In an embodiment, some or all of the estimated tire health variables may be accumulated over time and optionally aggregated in a manner to support analytics such as for example trend analysis (step 360). The tire-specific aggregation and further analytics may for example further enable the prediction of future tire health variables (step 370), wherein for example output signals generated by the system (step 380) may correspond to a health of the respective tire based on a comparison of certain estimated tire health variables and/or on a predicted future tire health variable.

In an embodiment, and for subsequent iterations of a method 300 as described above, the selection of appropriate models may be based on a newly measured set of the input values and further on the above-referenced historical analysis of aggregated estimated respective tire health variables over time.

For example, an implementation of the method 300 may include aggregating certain estimated tire health variables over time and predicting a remaining useful life of the tire based at least in part on the aggregated variables, wherein an output signal corresponds to the predicted remaining useful life of the tire. An output signal may for example be generated corresponding to a lowest predicted life remaining from among a plurality of estimated tire health variables. An output signal may further or in the alternative be generated corresponding to a predicted life remaining based on a combination of interrelated tire health variables as identified from the selected models.

In various embodiments, output signals may be selectively generated to a display unit associated with a user interface based on a determined passive intervention alert condition (step 382). In other embodiments, output signals may be selectively generated to one or more vehicle control units based on a determined active intervention alert condition (step 384). However, these embodiments are by no means exclusive and it may be anticipated that output signals may be generated to either or both of display units and vehicle control units for a given system configuration and optionally dependent on a type of alert condition. For example, a passive alert may be generated to indicate a predicted condition, which may be converted to an active alert if the condition is not addressed or otherwise if a predetermined threshold/range is violated.

In an embodiment, an estimated or predicted tire health state may be provided as an output from the model to one or more downstream models or applications. For example, a predicted tread depth status may be generated as feedback or feed-forward signals to a vehicular control system, a traction model (in the same system or as part of another system functionally linked thereto), and/or another predictive model associated with fuel efficiency, durability, or the like. The tire state information (e.g., tread depth) may for example be provided along with certain vehicle data as inputs to the traction model, which may be configured to provide an estimated traction status or one or more traction characteristics for the respective tire. An exemplary traction model may comprise “digital twin” virtual representations of physical parts, processes or systems wherein digital and physical data are paired and combined with learning systems such as for example artificial neural networks. Real vehicle data and/or tire data from a particular tire, vehicle or tire-vehicle system may be provided throughout the life cycle of the respective asset to generate a virtual representation of the vehicle tire for estimation of tire traction, wherein subsequent comparison of the estimated tire traction with a corresponding measured or determined actual tire traction may preferably be implemented as feedback for machine learning algorithms executed at the server level.

An exemplary traction model may further utilize the results from prior testing, including for example stopping distance testing results, tire traction testing results, etc., as collected with respect to numerous tire-vehicle systems and associated combinations of tire state values for input parameters (e.g., tire tread, inflation pressure, road surface characteristics, vehicle speed and acceleration, slip rate and angle, normal force, braking pressure and load), wherein a tire traction output may be effectively predicted for a given set of current vehicle data and tire data inputs.

In one embodiment, the outputs from this traction model may be incorporated into an active safety system, an autonomous fleet management system, or the like. As previously noted, data may be collected from sensors on the vehicle to feed into the tire wear model which will predict tread depth, and this data may further be fed into a traction model. The term “active safety systems” as used herein may preferably encompass such systems as are generally known to one of skill in the art, including but not limited to examples such as collision avoidance systems, advanced driver-assistance systems (ADAS), anti-lock braking systems (ABS), etc., which can be configured to utilize the traction model output information to achieve optimal performance. For example, collision avoidance systems are typically configured to take evasive action, such as automatically engaging the brakes of a host vehicle to avoid or mitigate a potential collision with a target vehicle, and enhanced information regarding the traction capabilities of the tires and accordingly the braking capabilities of the tire-vehicle system are eminently desirable.

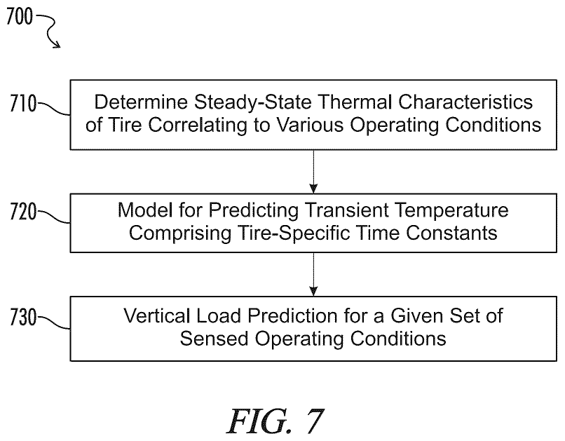

As previously noted, various inputs to the system may be directly measured or otherwise indirectly determined. Vertical load on a tire may be a desired input to the system for implementation in various models and algorithms, but one that is frequently unavailable for direct measurement during use. Referring next to FIG. 7, an exemplary process 700 is further provide for prediction of vertical load on the tire from several of the above-referenced and generally available sensor measurements (e.g., speed, ambient temperature, inflation pressure, and CAT).

In one step 710, a tire's thermal characteristics (e.g., steady-state thermal characteristics) are determined as correlating with various operating conditions. In various embodiments, this determination can be made via physical measurements, or alternatively via finite element analysis, other equivalent techniques, or a mix thereof. In an exemplary embodiment, the steady-state contained air temperature is determined at several different vertical loads, speeds, and inflation pressures. All of these conditions are then compiled into one parameter, which is the vertical load multiplied by the speed (essentially a power input to the tire) divided by the inflation pressure.

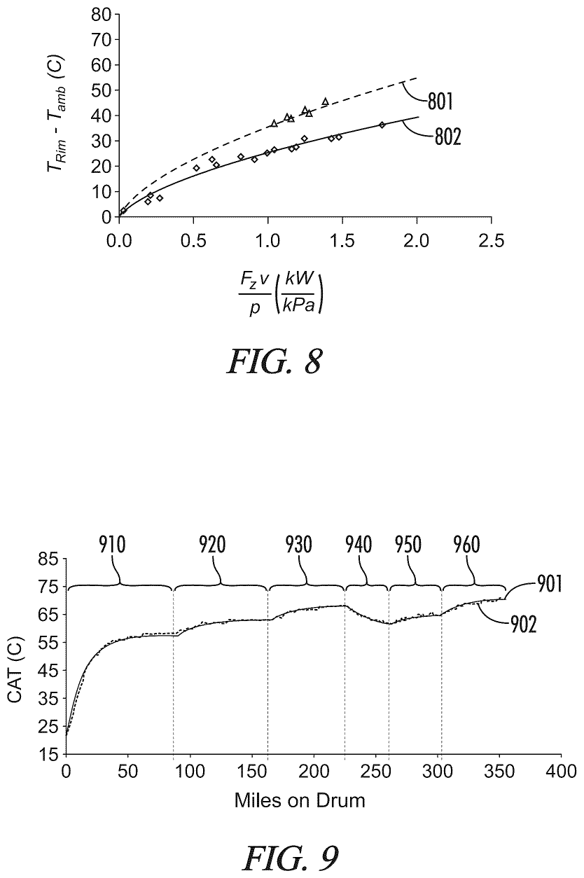

FIG. 8 shows two examples of data curves, with a first curve 801 produced via outdoor testing results from physical measurements, and a second curve 802 produced via finite element analysis simulations. The data as represented in the present embodiment take the form ΔT=A*(Fz*v/p)\hat{ }b, where ΔT is the difference between CAT (or Tᵣᵢₘ) and ambient temperature (or T_{amb}), F is the vertical load, r is the vehicle speed, p is the tire's inflation pressure, and A and b are coefficients to be determined. For the exemplary curve 801, coefficient A is determined to be 25 and coefficient b is determined to be 0.65. For the exemplary curve 302, coefficient A is determined to be 35 and coefficient b is determined to be 0.65.

In another step 720, in order to predict transient temperature, the tire may be treated as a lumped capacitance model, wherein for example the only parameter needed is t, a time constant. This time constant t may be different depending on whether the tire is heating or cooling. As one example, based on limited data gathered from truck and bus radial (TBR) tires of size 295/75R22.5 R283, the cooling time constant tool is determined to be 2500 seconds, and the heating time constant τₕₑₐₜ is determined to be 1250 seconds. One of skill in the art may appreciate that these time constants will likely vary from tire to tire, especially for tires of different sizes, and therefore these constants would need to be determined from experimental data.

FIG. 9 represents a comparison of predicted contained air temperature 901 with respect to measured contained air temperature 902 for a controlled indoor drum test with variance in both of the speed and the vertical load. In a first block of test mileage 910, the speed is 40 miles per hour (mph) and the load is 6173 pounds of force (lbf). In a second block of test mileage 920, the speed is 50 mph and the load is 6173 lbf. In a third block of test mileage 930, the speed is 60 mph and the load is 6173 lbf. In a fourth block of test mileage 940, the speed is 40 mph and the load is 6614 lbf. In a fifth block of test mileage 950, the speed is 50 mph and the load is 6614 lbf. In a sixth block of test mileage 960, the speed is 60 mph and the load is 6614 lbf.

When a TPMS device 118 is implemented as previously noted, the contained air temperature measurements 902 may typically be directly obtained therefrom. This allows for the previously stated model to be used to predict the unknown variable, i.e., vertical load. For the embodiment shown in FIG. 9, if this method is applied, the vertical loads are predicted within 120N of the actual value. One of skill in the art may appreciate that this data can be very sparse and/or noisy when viewed instantaneously with respect to vehicle conditions, but that the noise may be filtered or otherwise minimized via smoothed analysis over larger periods of time, such as for example over a 24-hour period for a long haul truck route. This may appreciably impact the capability of a typical system to more accurately predict wear and durability.

Throughout the specification and claims, the following terms take at least the meanings explicitly associated herein, unless the context dictates otherwise. The meanings identified below do not necessarily limit the terms, but merely provide illustrative examples for the terms. The meaning of “a,” “an,” and “the” may include plural references, and the meaning of “in” may include “in” and “on.” The phrase “in one embodiment,” as used herein does not necessarily refer to the same embodiment, although it may.

The various illustrative logical blocks, modules, and algorithm steps described in connection with the embodiments disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

The various illustrative logical blocks and modules described in connection with the embodiments disclosed herein can be implemented or performed by a machine, such as a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor can be a microprocessor, but in the alternative, the processor can be a controller, microcontroller, or state machine, combinations of the same, or the like. A processor can also be implemented as a combination of computing devices, e.g., a combination of a DSP and a microprocessor, a plurality of microprocessors, one or more microprocessors in conjunction with a DSP core, or any other such configuration.

The steps of a method, process, or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of computer-readable medium known in the art. An exemplary computer-readable medium can be coupled to the processor such that the processor can read information from, and write information to, the memory/storage medium. In the alternative, the medium can be integral to the processor. The processor and the medium can reside in an ASIC. The ASIC can reside in a user terminal. In the alternative, the processor and the medium can reside as discrete components in a user terminal.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

Whereas certain preferred embodiments of the present invention may typically be described herein with respect to tire wear estimation for fleet management systems and more particularly for autonomous vehicle fleets or commercial trucking applications, the invention is in no way expressly limited thereto and the term “vehicle” as used herein unless otherwise stated may refer to an automobile, truck, or any equivalent thereof, whether self-propelled or otherwise, as may include one or more tires and therefore require accurate estimation or prediction of tire wear and potential disabling, replacement, or intervention in the form of for example direct vehicle control adjustments.

The term “user” as used herein unless otherwise stated may refer to a driver, passenger, mechanic, technician, fleet management personnel, or any other person or entity as may be, e.g., associated with a device having a user interface for providing features and steps as disclosed herein.

The previous detailed description has been provided for the purposes of illustration and description. Thus, although there have been described particular embodiments of a new and useful invention, it is not intended that such references be construed as limitations upon the scope of this invention except as set forth in the following claims.

What is claimed is:

1. A computer-implemented tire health estimation method comprising:
aggregating model generation data in data storage over time, and iteratively generating a plurality of tire health models based on the aggregated model generation data, said model generation data correlating various combinations of a first set of input values for a given type of tire to each of one or more tire health variables for each of a plurality of tire components;
measuring and/or determining a second set of the input values via one or more sensors associated with a first tire of the given type of tire and/or associated with a vehicle upon which the first tire is mounted;
selecting an appropriate model for at least one of the one or more tire health variables with respect to each of one or more of the plurality of tire components based on the measured second set of the input values;
estimating respective tire health variables for each of the at least one tire component via the one or more selected models and based on the measured second set of the input values; and
generating an output signal corresponding to a health of the first tire based on a comparison of the estimated tire health variables.

2. The method of claim 1, wherein at least one of the input values are directly measured via the one or more sensors and at least one of the input values are determined indirectly via the at least one directly measured input value.

3. The method of claim 1, wherein the plurality of selectable tire health models comprises fatigue estimation models corresponding to relevant fracture variables for one or more of the plurality of tire components.

4. The method of claim 3, wherein the fatigue estimation models comprise crack growth rate models for estimating crack growth rates at each of a plurality of locations on the tire and as a function of at least an estimated strain and temperature at each of the plurality of locations.

5. The method of claim 1, further comprising aggregating the estimated respective tire health variables over time and predicting a remaining useful life of the tire based at least in part on the aggregated variables, wherein the output signal corresponds to the predicted remaining useful life of the tire.

6. The method of claim 5, further comprising selecting appropriate models for subsequent iterations of the method based on a newly measured set of the input values and further on historical analysis of the aggregated estimated respective tire health variables over time.

7. The method of claim 1, wherein the plurality of selectable tire health models comprise aging estimation models accounting for tire-series changes in relevant variables for one or more of the plurality of tire components relative to the type of the first tire.

8. The method of claim 1, wherein the plurality of selectable tire health models comprise damage estimation models accounting for determined external impacts relevant to tire health for one or more of the plurality of tire components.

9. The method of claim 1, wherein the plurality of selectable tire health models comprise tire wear estimation models accounting for a determined and/or predicted tread depth.

10. The method of claim 1, wherein the plurality of selectable tire health models comprise one or more carcass health models for predicting a remaining useful life of the tire based at least in part on a predicted time before occurrence of conditions selected from a group consisting of: belt edge separation; belt leaving belt; belt leaving carcass; and ply end separation.

11. The method of claim 1, wherein the output signal is generated corresponding to a lowest predicted life remaining from among the estimated tire health variables.

12. The method of claim 1, wherein the output signal is generated corresponding to a predicted life remaining based on a combination of interrelated tire health variables as identified from the selected models.

13. The method of claim 1, wherein the output signal is selectively generated to a display unit associated with a user interface based on a determined passive intervention alert condition.

14. The method of claim 1, wherein the output signal is selectively generated to one or more vehicle control units based on a determined active intervention alert condition.

15. A tire health estimation system comprising:
data storage having stored thereon model generation data aggregated over time, and a plurality of tire health models iteratively generated based on the aggregated model generation data, said model generation data correlating various combinations of a first set of input values for a given type of tire to each of one or more tire health variables for each of a plurality of tire components; and
a computer program product residing on a non-transitory computer readable medium and executable by a processor to direct performance of operations comprising:
generating a second set of the input values via direct measurement of certain ones of the values from one or more sensors associated with a first tire of the given type of tire and/or associated with a vehicle upon which the first tire is mounted and/or via indirect determination of certain ones of the values from directly measured values;
selecting an appropriate model for at least one of the one or more tire health variables with respect to each of one or more of the plurality of tire components based on the measured second set of the input values;
estimating respective tire health variables for each of the at least one tire component via the one or more selected models and based on the measured second set of the input values; and
generating an output signal corresponding to a health of the first tire based on a comparison of the estimated tire health variables.

16. The system of claim 15, wherein:
the plurality of selectable tire health models comprises fatigue estimation models corresponding to relevant fracture variables for one or more of the plurality of tire components, and
the fatigue estimation models comprise crack growth rate models for estimating crack growth rates at each of a plurality of locations on the tire and as a function of at least an estimated strain and temperature at each of the plurality of locations.

17. The system of claim 15, wherein the computer program product further directs the performance of aggregating the estimated respective tire health variables over time and predicting a remaining useful life of the tire based at least in part on the aggregated variables, wherein the output signal corresponds to the predicted remaining useful life of the tire.

18. The system of claim 17, wherein the computer program product further directs the performance of selecting appropriate models for subsequent iterations of the method based on a newly measured set of the input values and further on historical analysis of the aggregated estimated respective tire health variables over time.

19. The system of claim 15, wherein the plurality of selectable tire health models comprise one or more of:
aging estimation models accounting for tire-series changes in relevant variables for one or more of the plurality of tire components relative to the type of the first tire;
damage estimation models accounting for determined external impacts relevant to tire health for one or more of the plurality of tire components; and
tire wear estimation models accounting for a determined and/or predicted tread depth.

20. The system of claim 15, wherein the plurality of selectable tire health models comprise one or more carcass health models for predicting a remaining useful life of the tire based at least in part on a predicted time before occurrence of conditions selected from a group consisting of: belt edge separation; belt leaving belt; belt leaving carcass; and ply end separation.
